(19) United States
(12) Patent Application Publication
(10) Pub. No.: US 2009/0073481 A1
(43) Pub. Date: Mar. 19, 2009

(54) Method and system for external preprocessing of service requests directed to a sleeping node

(76) Inventors: Andrew R. Ferlitsch, Camas, WA (US); Craig T. Whittle, Vancouver, WA (US)

Correspondence Address: SHARP LABORATORIES OF AMERICA, INC., 1320 PEARL ST., SUITE 228, BOULDER, CO, 80302, US

(21) Appl. No.: 11/901,386

(22) Filed: Sep. 17, 2007

(51) Int. Cl. G06K 15/02

(52) U.S. Cl. 358/1.14

(57) ABSTRACT

Methods and systems for external preprocessing of service requests to avoid unnecessary wakeup of a sleeping node and improve power savings. An exemplary method comprises receiving from a sleep capable node a redirected service request; and selecting, depending on a service request type of the service request, among transmitting to the sleep capable node a wakeup request and providing to a client node a service requested in the service request without transmitting to the sleep capable node a wakeup request. In some embodiments, the selecting step comprises selecting among transmitting to the sleep capable node a full wakeup request, transmitting to the sleep capable node a partial wakeup request and providing to the client node a service requested in the service request without transmitting to the sleep capable node a wakeup request.

### BACKGROUND OF THE INVENTION

The present invention relates to intelligent processing of service requests in a communication network and, more particularly, to preprocessing of service requests to avoid unnecessary wakeup of sleeping components of a network node.

Service providing network nodes, such as multifunction printers (MFPs), have traditionally supported a full power mode and a power saving mode. In the power saving mode, electromechanical components, such as an MFP print engine, are put to sleep (i.e. powered-down) while digital processing components, such as an MFP CPU and controllers, remain awake (i.e. powered-up). Because the processing components remain awake, these service providing network nodes can fulfill inbound service requests that do not require the electromechanical components while remaining in power saving mode. When a service request requires electromechanical components, the digital processing components can awaken the electromechanical components and the request can be fulfilled by the electromechanical components once awake. Unfortunately, because the digital processing components are always awake, power savings are limited.

Some service providing network nodes have improved power savings by supporting a more comprehensive sleep mode in which all components except for nodal interfaces (e.g. network interface) are powered-down. In these nodes, when an inbound service request is received, the network interface awakens both the digital processing components and the electromechanical components and the service request is fulfilled once both sets of components are awake. While the overall power conservation profile is improved, the client node that issues the service request may time-out waiting for the digital processing components to power-up. Moreover, the electromechanical components in these nodes are awakened even if the service request does not require them, for example, even if the service request is a mere request for information accessible to the digital processing components of the node.

### SUMMARY OF THE INVENTION

The present invention, in a basic feature, provides external preprocessing of service requests to avoid unnecessary wakeup of a sleeping node. The external preprocessing has at least three possible outcomes. First, service requests directed to a sleeping node that are serviceable by an alternate node are serviced by the alternate node without waking the sleeping node. Second, service requests directed to a sleeping node that are not serviceable by an alternate node but are serviceable by light sleeping components of the sleeping node are serviced by the light sleeping components without waking deep sleeping components of the sleeping node. Third, service requests directed to a sleeping node that are not serviceable by an alternate node or by light sleeping components of the sleeping node are serviced by deep sleeping components of the sleeping node. Through this external preprocessing, sleeping components of a sleeping node that do not need to be awakened to service a service request are not awakened, improving power savings. The external preprocessing is provided in some embodiments by a sleep management node to which the sleeping node is communicatively coupled and to which the sleeping node redirects service requests.

In one aspect, the present invention provides a sleep capable node comprising a network interface and sleeping components wherein the sleep capable node redirects a service request received on the network interface to a sleep management node to which the sleep capable node is communicatively coupled in response to which the sleep capable node selectively receives on the network interface from the sleep management node, depending on a service request type of the service request, a wakeup request prompting the sleep capable node to awaken at least some of the sleeping components. In some embodiments, the wakeup request is a full wakeup request which prompts the sleep capable node to awaken all sleeping components. In some embodiments, the wakeup request is a partial wakeup request which prompts the sleep capable node to awaken fewer than all of the sleeping components. In some embodiments, the sleep capable node transmits to the sleep management node a sleep profile associating at least one service request type with full wakeup, at least one service request type with partial wakeup and at least one service request type with no wakeup.

In another aspect, the present invention provides a sleep management node comprising at least one network interface and a processor communicatively coupled with the network interface wherein the processor receives via the network interface from a sleep capable node a redirected service request in response to which the processor selects, depending on a service request type of the service request, among transmitting via the network interface to the sleep capable node a wakeup request and providing to a client node a service requested in the service request without transmitting to the sleep capable node a wakeup request. In some embodiments, the processor selects, depending on a service request type of the service request, among transmitting via the network interface to the sleep capable node a full wakeup request, transmitting via the network interface to the sleep capable node a partial wakeup request and providing to the client node a service requested in the service request without transmitting to the sleep capable node a wakeup request. In some embodiments, the sleep management node receives from the sleep capable node a sleep profile associating at least one service request type with no wakeup and at least one service request type with wakeup. In some embodiments, the sleep management node receives from the sleep capable node a sleep profile associating at least one service request type with no wakeup, at least one service request type with full wakeup and at least one service request type with partial wakeup. In some embodiments, the processor provides the service to the client node without resort to a fourth node. In some embodiments, the processor invokes a fourth node to provide the service to the client node.

In yet another aspect, the present invention provides a method for external preprocessing of service requests directed to a sleep capable node, comprising receiving from a sleep capable node a redirected service request; and selecting, depending on a service request type of the service request, among transmitting to the sleep capable node a wakeup request and providing to a client node a service requested in the service request without transmitting to the sleep capable node a wakeup request.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a system for external preprocessing of service requests directed to a sleep capable node in some embodiments of the invention.

FIG. 2 shows the sleep capable node in the system of FIG. 1 in more detail.

FIG. 3 shows the sleep management node in the system of FIG. 1 in more detail.

FIG. 4 shows sleep profile message flows in the system of FIG. 1.

FIG. 5 shows message flows through which a non-awakening service request is processed in the system of FIG. 1.

FIG. 6 shows message flows through which a partially awakening service request is processed in the system of FIG. 1.

FIG. 7 shows message flows through which a fully awakening service request is processed in the system of FIG. 1.

FIG. 8 shows a method performed by a sleep capable node in some embodiments of the invention.

FIG. 9 shows a method performed by a sleep management node in some embodiments of the invention.

### DETAILED DESCRIPTION OF A PREFERRED EMBODIMENT

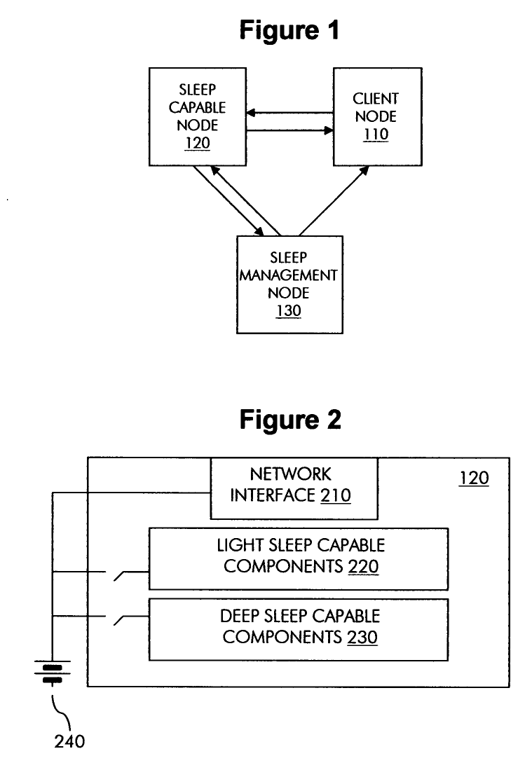

FIG. 1 shows a system for external preprocessing of service requests directed to a sleep capable node 120 in some embodiments of the invention. The system includes a client node 110, sleep capable node 120 and a sleep management node 130, all of which are communicatively coupled via a data communication network that includes one or more local area networks (LANs), wide area networks (WANs), WiMax networks, ad-hoc networks or other networks. In some embodiments, the data communication network traverses the Internet. While one client node 110, one sleep capable node 120 and one sleep management node 130 are shown, a system within the scope of the invention may have one or more client nodes, one or more sleep capable nodes and one or more sleep management nodes. Systems wherein a sleep management node provides external preprocessing of service requests for multiple sleep capable nodes are specifically contemplated.

Client node 110 is a data communication device, such as a desktop personal computer, laptop personal computer, workstation, cellular phone or personal data assistant (PDAs), that desires access to services offered by sleep capable node 120. Access to services offered by sleep capable node 120 is requested by issuing to sleep capable node 120 peer-to-peer service requests via a wired or wireless network interface of client node 110, such as a LAN, WAN or cellular interface. Peer-to-peer service requests may be transmitted using numerous communication protocols, such as Transmission Control Protocol over Internet Protocol (TCP/IP), AppleTalk, Bluetooth, Infrared Data Association (IrDA), Wi-Fi or WiMax, for example. Access to services offered by sleep capable node 120 is regulated by sleep management node 130, which preprocesses service requests issued by client node 110 to avoid unnecessary wakeup of sleeping components of sleep capable node 120. Client node 110 has a user interface, a network interface and a memory communicatively coupled with a microprocessor. The user interface has an input mechanism, such as a keyboard, keypad, touch-sensitive navigation tool, or voice recognition interface for accepting inputs from a user and an output mechanism, such as a liquid crystal display (LCD), light emitting diode (LED) display, cathode ray tube (CRT) or electronic ink display (eInk) for displaying outputs to a user. The network interface communicatively couples client node 110 to sleep capable node 120 and sleep management node 130 via a communication network. The memory includes one or more random access memories (RAMs) and one or more read only memories (ROMs). An operating system installed in the memory and executed by the CPU manages operations on client node 110 by creating, scheduling and performing various tasks, among them generating service requests conformant with inputs on user interface and transmitting the service requests on the network interface.

Sleep capable node 120 is shown in FIG. 2 to include a network interface 210, light sleep capable components 220 and deep sleep capable components 230, all of which are communicatively coupled. Network interface 210 and sleep capable components 220, 230 are powered by a power source 240, with the supply of power to sleep capable components 220, 230 being regulated based on their current sleep state. Network interface 210 includes one or more of a LAN interface, WAN interface, Universal Serial Bus (USB) port, IRDA or Small Computer System Interface (SCSI), for example, and is always awake. Network interface 210 is responsible for transmitting to sleep management node 130 sleep profiles, redirecting to sleep management node 130 service requests received from client node 110 when sleep capable components 220, 230 are asleep, and fulfilling wakeup requests received from sleep management node 130 when sleep capable components 220, 230 require awakening. The role of network interface 210 in fulfilling wakeup requests may include, for example, signaling a bootstrap component to initiate power-up of sleep capable components 220, 230. Network interface 210 may include one or more network interface cards (NICs) or cellular interface cards (CICs) each having one or more integrated circuits (ICs) for performing its respective functions. Light sleep capable components 220 are service elements that are awakened in response to full and partial wakeup requests received from sleep management node 130. Deep sleep capable components 230 are service elements that are awakened in response to full wakeup requests received from sleep management node 130, but are not awakened in response to partial wakeup requests received from sleep management node 130.

In some embodiments, sleep capable node 120 is an MFP that supports multiple functions, such as printing, scanning, copying faxing, filing and publishing. In these embodiments, light sleep capable components 220 comprise digital processing elements, including a microprocessor and a memory, and deep sleep capable components 230 comprise electromechanical elements, such as a scan/copy engine, a print engine, audio/visual (A/V) components, displays, input devices, and document assembly components, for example. The scan/copy engine includes scanner/copier logic, such as one or more ICs, and a mechanical section for performing a scanning and copying functions. For example, the scan/copy engine may have a line image sensor mounted on a movable carriage for optically scanning a document under the control of a scanner IC and storing the scanned document. The print engine includes printer logic, such as one or more ICs, and a mechanical section for performing printing functions. For example, the print engine may have a color ink jet head mounted on a movable carriage for printing a document under the control of a printer IC. Network interface 210 is communicatively coupled with the digital processing elements and the electromechanical elements internal to sleep capable node 120. In other embodiments, a sleep capable node may be a non-MFP device, such as a copy machine, scanner, fax machine, filing device, publishing device, A/V recorder/player, compact/digital video disc (CD/DVD) recorder/player, desktop personal computer, laptop personal computer, workstation, cellular phone or PDA, that supports deep and light sleep capable components.

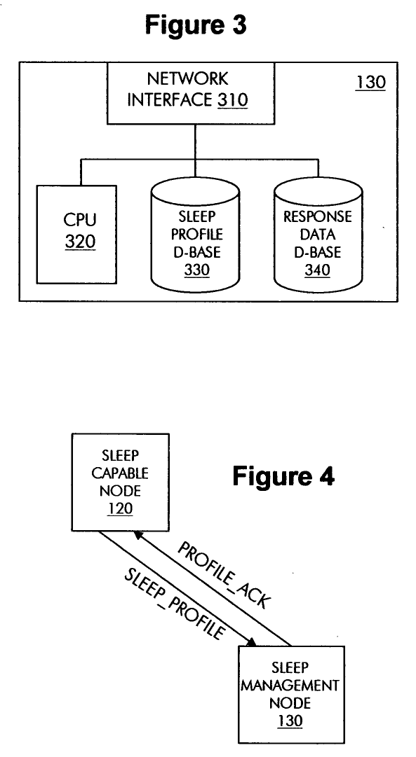

FIG. 3 shows sleep management node 130 to include a network interface 310, a microprocessor 320, a sleep profile database 330 and a response data database 340, all of which are communicatively coupled. Network interface 310 includes one or more of a LAN interface, WAN interface, USB port, SCSI or cellular interface, for example. Network interface 310 is responsible for transmitting and receiving to and from client node 110 and sleep capable node 120 messages, including sleep profile-related messages and service request-related messages. In some embodiments, a secure communication link is established between sleep capable node 120 and sleep management node 130 before such messages are exchanged. Microprocessor 320 has software executable thereon for preprocessing redirected service requests received from sleep capable node 120 in a manner that provides services requested by client node 110 while avoiding unnecessary wakeup of sleeping components of sleep capable node 120, which requires managing and accessing of databases 330, 340. Sleep profile database 330 stores the current sleep profile of sleep capable node 120. Response data database 340 stores response data associated with sleep capable node 120 that sleep management node 130 may include in responses to service requests made by sleep management node 130 on behalf of sleep capable node 120. In some embodiments, databases 330, 340 are maintained in one or more memories on sleep management node 130 that may include RAMs and ROMs. In other embodiments, one or both of the databases may be maintained on a separate node to which sleep management node 130 is communicatively coupled.

FIG. 4 shows sleep profile message flows within the system of FIG. 1. Before sleep capable node 120 enters a full sleep state in which sleep capable components 220, 230 are powered-down, sleep capable node 120 transmits to sleep management node 130 a sleep profile (SLEEP_PROFILE). The sleep profile identifies a sleep state (e.g. full sleep) and classifies different service request types into different classes, including a non-awakening (NA) class, a partially awakening (PA) class and a fully awakening (FA) class. The NA class includes service request types that can be handled by an alternate node without waking any sleeping components of sleep capable node 120. The PA class includes service request types that require waking of light sleep capable components 220 but do not require waking of deep sleep capable components 230. The FA class includes service request types that require waking of both light sleep capable components 220 and deep sleep capable components 230. In some embodiments, service request types within the FA class are omitted from the sleep profile and all service request types that are not classified into the NA or PA class are presumed by sleep management node 130 to belong to the FA class. A sleep profile for sleep capable node 120 is generated under the control of microprocessor 320 from the sleep profile and stored in sleep profile database 330, wherein service request types are stored in association with their respective classes. Sleep profiles may be transmitted in broadcast, multicast or unicast messages. To support unicasting of sleep profiles, the network address of sleep capable node 130 may be configured on sleep capable node 120 by a network administrator or may be learned by sleep capable node 120 through an advertisement or registration protocol such as Web Services Dynamic Discovery (WS-Discovery), for example.

In some embodiments, service request types within the NA class include requests for information about sleep capable node 120, such as requests for node type or feature matches (e.g. match or no match), node type or feature information (e.g. device speed, model, location), node configuration information, default node settings, node resource levels (e.g. toner level, paper level) and metadata.

In some embodiments, service request types within the PA class include requests to make operational changes to sleep capable node 120, such as configuration change requests, default device settings change requests, access authorization change requests and firmware and software change requests.

In some embodiments, service request types within the FA class include requests for primary services of sleep capable node 120, such as print, copy, scan and fox requests.

Sleep profiles also include, for each service request type within the NA class, response data that is to be provided to client node 110 in response to service requests of the service request type. In some embodiments, such response data is transmitted to sleep management node 130 by sleep capable node 120 unprompted as part of the sleep profile. In other embodiments, sleep management node 130 queries sleep capable node 120 for such response data. In either event, sleep management node 130 stores in response data database 340 under the control of microprocessor 320 different service request types within the NA class and associated response data.

After completion of sleep profile processing, sleep management node 130 transmits to sleep capable node 120 a sleep profile acknowledgement (PROFILE_ACK). Sleep capable node 120 enters the sleep state advertised in the sleep profile (e.g. full sleep) upon receiving the sleep profile acknowledgment.

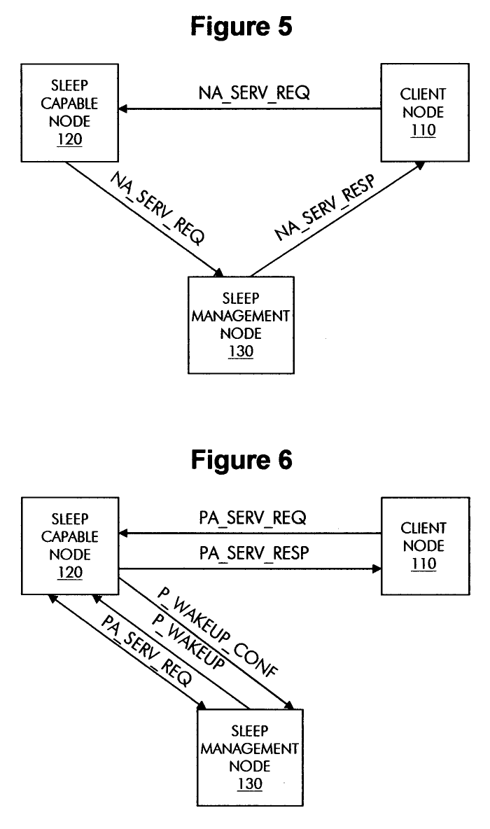

FIG. 5 shows message flows through which an NA service request (NA_SERV_REQ) is processed in the system of FIG. 1 when sleep capable node 120 is in a full sleep state. An NA service request is a request for a service that can be fulfilled by an alternate node, such as sleep management node 130 or another service providing node to which sleep management node 130 is communicatively coupled, without waking any sleeping components of sleep capable node 120. In the message flow, client node 110 issues an NA service request that is directed to sleep capable node 120. The NA service request may be addressed to a network address of sleep capable node 120 that is known to client node 110 or may be addressed to a network address of a request management node known to client node 110 that distributes the NA service request to sleep capable node 120. In either event, the NA service request arrives at the always awake network interface 210 of sleep capable node 120. Network interface 210 identifies the message as other than a wakeup request based on information in the message header and/or payload. Once identified as such, network interface 210 redirects the NA service request to sleep management node 130 without waking sleep capable components 220, 230.

Upon arrival of the NA service request at sleep management node 130 via network interface 310, microprocessor 320 identifies the service request type of the NA service request from information in the message header and/or payload and classifies the request into the NA class through the stored association in service profile database 330 of the identified service request type with the NA class. Once classified into the NA class, microprocessor 320 determines response data for the NA service request through the stored association in response data database 340 of the identified service request type with certain response data. Microprocessor 320 then generates and transmits to client node 110 via network interface 310 an NA service response (NA_SERV_RESP) in fulfillment of the NA service request. In other embodiments, sleep management node 130 invokes another service providing node (other than sleep capable node 120) to determine appropriate response data for the message and/or fulfill the NA service request.

FIG. 6 shows message flows through which a partially awakening service request (PA_SERV_REQ) is processed in the system of FIG. 1 when sleep capable node 120 is in a deep sleep state. A PA service request is a request for a service that requires waking of light sleep capable components 220 of sleep capable node but does not require waking of deep sleep capable components of sleep capable node 120. In the message flow, client node 110 issues a PA service request that is directed to sleep capable node 120. Network interface 210 identifies the message as other than a wakeup request based in information in the message header and/or payload. Once identified, network interface 210 redirects the PA service request to sleep management node 130 without waking sleep capable components 220, 230.

Upon arrival of the PA service request at sleep management node 130 via network interface 310, microprocessor 320 identifies the service request type of the PA service request from information in the message header and/or payload and classifies the request into the PA class through the stored association in service profile database 330 of the identified service request type with the PA class. Once classified into the PA class, microprocessor 320 generates and transmits to sleep capable node 120 via network interface 310 a partial wakeup request (P_WAKEUP).

Upon arrival of the partial wakeup request at sleep capable node 120 via network interface 210, network interface 210 identifies the message as a partial wakeup request based on information in the message header and/or payload. Once identified as such, network interface 210 initiates wakeup of light sleep capable components 220 without awakening deep sleep capable components 230. In some embodiments, network interface 210 signals a bootstrap component to initiate power-up of light sleep capable components 220. Once light sleep capable components 220 have fully awakened, network interface 210 transmits to sleep management node 130 a partial wakeup confirmation (P_WAKEUP_CONF) to apprise sleep management node 130 of the partial sleep state that sleep capable node 120 has entered. Then, sleep management node 130 redirects the PA service request to sleep capable node 120 and light sleep capable components 220 fulfill the PA service request including generating and transmitting to client node 110 via network interface 210 a PA service response (PA_SERV_RESP).

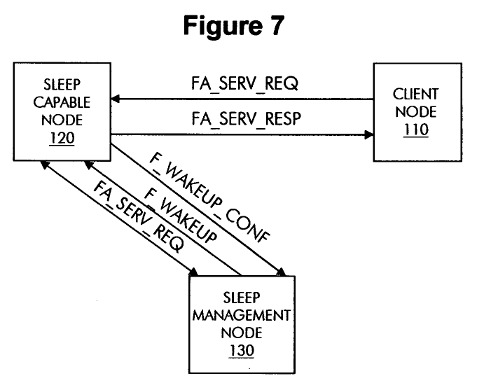

FIG. 7 shows message flows through which a fully awakening service request (FA_SERV_REQ) is processed in the system of FIG. 1 when sleep capable node 120 is in a full sleep state. An FA service request includes a request for a service that requires waking of light sleep capable components 220 of sleep capable node 120 and deep sleep capable components 230 of sleep capable node 120. In the message flow, client node 110 issues a FA service request that is directed to sleep capable node 120. Network interface 210 identifies the message as other than a wakeup request based in information in the message header and/or payload. Once identified, network interface 210 redirects the FA service request to sleep management node 130 without waking sleep capable components 220, 230.

Upon arrival of the FA service request at sleep management node 130 via network interface 310, microprocessor 320 identifies the service request type of the FA service request from information in the message header and/or payload and classifies the request into the FA class through the stored association in service profile database 330 of the identified service request type with the FA class. Once classified into the FA class, microprocessor 320 generates and transmits to sleep capable node 120 via network interface 310 a full wakeup request (F_WAKEUP).

Upon arrival of the full wakeup request at sleep capable node 120 via network interface 210, network interface 210 identifies the message as a full wakeup request based on information in the message header and/or payload. Once identified as such, network interface 210 initiates wakeup of light sleep capable components 220 and deep sleep capable components 230. In some embodiments, network interface 210 signals a bootstrap component to initiate power-up of sleep capable components 220, 230. Once sleep capable components 220, 230 have fully awakened, network interface 210 transmits to sleep management node 130 a full wakeup confirmation (F_WAKEUP_CONF) to apprise sleep management node 130 of the fully awake state that sleep capable node 120 has entered. Then, sleep management node 130 redirects the FA service request to sleep capable node 120 and sleep capable components 220, 230 fulfill the FA service request including generating and transmitting to client node 110 via network interface 210 a FA service response (FA_SERV_RESP).

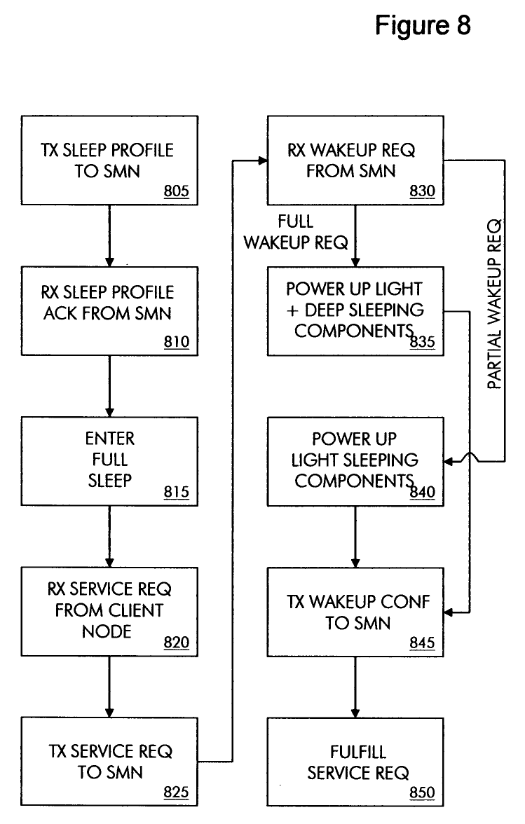

FIG. 8 shows a method performed by sleep capable node 120 in some embodiments of the invention. Before entering full sleep, sleep capable node 120 transmits a sleep profile to sleep management node (SMN) 130 (805) and receives a sleep profile acknowledgement from sleep management node 130 (810). Sleep capable node 120 then enters a full sleep state (815). Sleep capable node 120 eventually receives a service request from client node 110 (820) and in response redirects the service request to sleep management node 130 (825). Assuming the service request is an FA or PA service request, sleep capable node 120 receives a wakeup request from sleep management node 130 (830). If the wakeup request is a full wakeup request, sleep capable node 120 powers-up light sleep capable components 220 and deep sleep capable components 230 (835) and transmits a wakeup confirmation to sleep management node 130 (845). If the wakeup request is a partial wakeup request, sleep capable node 120 powers-up light sleep capable components 220 (840), but not deep sleep capable components 230, and transmits a wakeup confirmation to sleep management node 130 (845). Sleep capable node 120 then proceeds to fulfill the service request after it is redirected to sleep capable node 120 from sleep management node 130 (850). Naturally, if the service request is an NA service request, no wakeup request is received and both light sleeping components 220 and deep sleeping components 230 remain asleep.

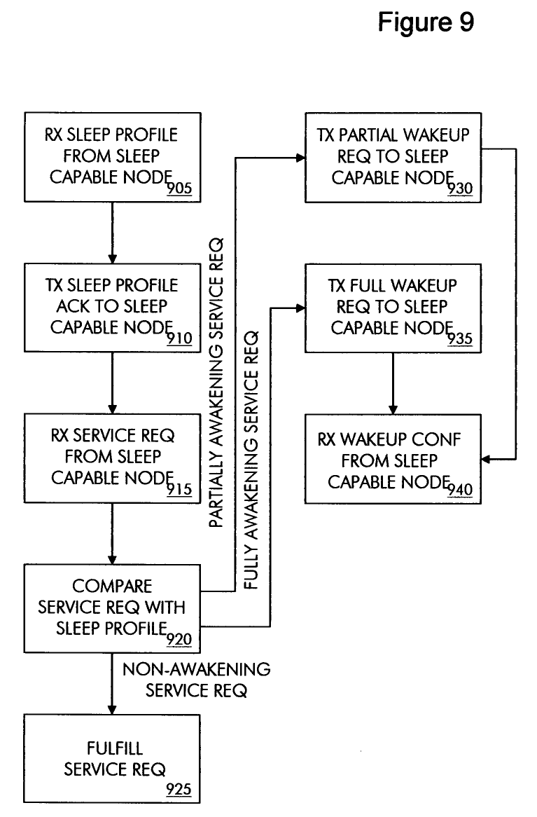

FIG. 9 shows a method performed by sleep management node 130 in some embodiments of the invention. Sleep management node 130 receives a sleep profile from sleep capable node 120 (905) and transmits a sleep profile acknowledgement to sleep capable node 120 (910). Sleep capable node 130 then eventually receives a redirected service request from sleep capable node 120 (915) and compares the service request with the sleep profile (920). If the service request is an NA service request, sleep management node 130 provides the requested service without waking any sleeping component of sleep capable node 120 (925) using response data associated with the sleep profile. If the service request is a PA service request, sleep management node 130 transmits a partial wakeup request to sleep capable node 120 (930) prompting power-up of light sleep capable components 220 without waking deep sleep capable components 230. If the service request is an FA service request, sleep management node 130 transmits a full wakeup request to sleep capable node 120 (935) prompting power-up of light sleep capable components 220 and deep sleep capable components 230. Sleep management node 130 thereafter receives a wakeup confirmation from sleep capable node 120 (940) and redirects the PA or FA service request to sleep capable node 120 for servicing by sleep capable node 120.

In some embodiments, sleep capable node 120 returns to a full sleep state immediately after fulfilling a PA service request. In other embodiments, sleep capable node 120 remains in a partial sleep state for a predetermined time after fulfilling a PA service request. In these embodiments, sleep capable node 120 services additional requests received within the predetermined time without redirecting them to sleep management node 130, awakening deep sleep capable components 230 to service any FA service requests.

In some embodiments, sleep capable node 120 returns to a full sleep state immediately after fulfilling an FA service request. In other embodiments, sleep capable node 120 remains in a fully awake state for a predetermined time after fulfilling an FA service request. In these embodiments, sleep capable node 120 services additional service requests received within the predetermined time without redirecting them to sleep management node 130.

When sleep capable node 120 is in a full sleep state, always awake network interface 210 identifies and differentiates full wakeup requests, partial wakeup requests and non-awakening messages using data extraction logic and comparators, which may be implemented in one or more ICs of network interface 210, for example. In some embodiments, full and partial wakeup requests always arrive on transmission control protocol (TCP), USB or cellular ports reserved for full and partial wakeup requests, respectively. In other embodiments, wakeup requests always arrive on a TCP, USB or cellular port reserved for wakeup requests and include byte signatures unique to full and partial wakeup requests, respectively, at a particular offset in the message payload. In still other embodiments, wakeup requests always arrive on an arbitrary TCP, USB or cellular port and include byte signatures unique to full and partial wakeup requests, respectively, at a particular offset in the message payload. In some of these embodiments, network interface 210 extracts port numbers and/or information at message offsets and compares the extracted data with pre-stored values to identify and differentiate full wakeup requests, partial wakeup requests and non-awakening messages.

When sleep capable node 120 is not in a full sleep state, network interface 210 relays inbound messages to light sleep capable components 220 for processing.

It will be appreciated by those of ordinary skill in the art that the invention can be embodied in other specific forms without departing from the spirit or essential character hereof. For example, in some embodiments, the system may support partitioned full wakeups in which deep sleep capable components on the sleep capable node are selectively awakened to fulfill service requests. In the case where the sleep capable node is an MFP, for example, in response to a redirected scan request a sleep management node may transmit to the MFP a wakeup request that prompts wakeup of the MFP's scan engine but not the print engine or the fax engine.

In other embodiments, a protocol may be operative in the system by which network nodes negotiate roles (e.g. sleep capable node, sleep management node, router) based on current sleep state.

In still other embodiments, a sleep management node may preprocess, or transmit to another service providing node for preprocessing, an FA service request while the sleep capable node from which the FA service request was received is waking-up, and then once the sleep capable node has awakened transmit the FA service request to the sleep capable node for subsequent processing.

The present description is therefore considered in all respects to be illustrative and not restrictive. The scope of the invention is indicated by the appended claims, and all changes that come with in the meaning and range of equivalents thereof are intended to be embraced therein.

What is claimed is:

1. A sleep capable node, comprising:
at least one network interface; and
sleep capable components in a sleep state, wherein the sleep capable node redirects a service request received on the network interface to a sleep management node to which the sleep capable node is communicatively coupled in response to which the sleep capable node selectively receives on the network interface from the sleep management node, depending on a service request type of the service request, a wakeup request prompting the sleep capable node to awaken from the sleep state at least some of the sleep capable components.

2. The sleep capable node of claim 1, wherein the wakeup request is a full wakeup request that prompts the sleep capable node to awaken from the sleep state all of the sleep capable components.

3. The sleep capable node of claim 1, wherein the wakeup request is a partial wakeup request that prompts the sleep capable node to awaken from the sleep state fewer than all of the sleep capable components.

4. The sleep capable node of claim 1, wherein the sleep capable node transmits to the sleep management node a sleep profile associating at least one service request type with full wakeup and at least one service request type with partial wakeup.

5. The sleep capable node of claim 1, wherein the sleep capable node transmits to the sleep management node a sleep profile associating at least one service request type with full wakeup, at least one service request type with partial wakeup and at least one service request type with no wakeup.

6. The sleep capable node of claim 1, wherein in response to awakening from the sleep state of at least some of the sleep capable components the sleep capable node transmits to the sleep management node a wakeup confirmation.

7. The sleep capable node of claim 6, wherein in response to transmission of the wakeup confirmation the sleep capable node receives from the sleep management node the service request.

8. The sleep capable node of claim 7, wherein in response to receipt from the sleep management node of the service request the sleep capable node fulfills the service request at least in part by invoking the awakened sleep capable components.

9. The sleep capable node of claim 1, wherein the network interface has logic adapted to identify an inbound message as a wakeup request based at least in part on information in the inbound message.

10. A sleep management node, comprising:
at least one network interface; and
a processor communicatively coupled with the network interface wherein the processor receives via the network interface from a sleep capable node a redirected service request in response to which the processor selects, depending on a service request type of the service request, among transmitting via the network interface to the sleep capable node a wakeup request and providing to a client node a service requested in the service request without transmitting to the sleep capable node a wakeup request.

11. The sleep management node of claim 10, wherein the sleep management node receives from the sleep capable node a sleep profile associating at least one service request type with no wakeup and at least one service request type with wakeup.

12. The sleep management node of claim 10, wherein the processor selects, depending on the service request type of the service request, among transmitting via the network interface to the sleep capable node a full wakeup request, transmitting via the network interface to the sleep capable node a partial wakeup request and providing to the client node a service requested in the service request without transmitting to the sleep capable node a wakeup request.

13. The sleep management node of claim 10, wherein the sleep management node receives from the sleep capable node a sleep profile associating at least one service request type with no wakeup, at least one service request type with full wakeup and at least one service request type with partial wakeup.

14. The sleep management node of claim 10, wherein the processor invokes a fourth node to provide the service to the client node.

15. A method for external preprocessing of service requests directed to a sleep capable node, comprising the steps of:
receiving from a sleep capable node a redirected service request; and
selecting, depending on a service request type of the service request, among transmitting to the sleep capable node a wakeup request and providing to a client node a service requested in the service request without transmitting to the sleep capable node a wakeup request.

16. The method of claim 15, further comprising the step of receiving from the sleep capable node a sleep profile associating at least one service request type with no wakeup and at least one service request type with wakeup.

17. The method of claim 15, wherein the selecting step comprises selecting among transmitting to the sleep capable node a full wakeup request, transmitting to the sleep capable node a partial wakeup request and providing to the client node a service requested in the service request without transmitting to the sleep capable node a wakeup request.

18. The method of claim 15, further comprising the step of receiving from the sleep capable node a sleep profile associating at least one service request type with no wakeup, at least one service request type with full wakeup and at least one service request type with partial wakeup.

19. The method of claim 15, further comprising the step of receiving from the sleep capable node in response to the wakeup request a wakeup confirmation.

20. The method of claim 19, further comprising the step of transmitting to the sleep capable node in response to the wakeup confirmation the service request.
